(19) United States
(12) Patent Application Publication
(10) Pub. No.: US 2026/0340148 A1
(43) Pub. Date: Oct. 29, 2026

(54) SYSTEM AND METHOD FOR AN INTERACTIVE OFFENSIVE CYBERSECURITY PLATFORM

(71) Applicant: AUTONOMOUS CYBER, INC., Sacramento, CA (US)

(72) Inventors: James Patrick O’BRIEN, Culver City, CA (US); Bohdan IVANENKO, Chicago, IL (US)

(73) Assignee: AUTONOMOUS CYBER, INC., Sacramento, CA (US)

(21) Appl. No.: 19/633,110

(22) Filed: Mar. 30, 2026

Related U.S. Application Data
(60) Provisional application No. 63/780,898, filed on Mar. 31, 2025.

(51) Int. Cl. G06F 21/57; G06F 11/3698

(52) U.S. Cl. CPC G06F 21/577; G06F 11/3698

(57) ABSTRACT

A cybersecurity system is configured to receive a user prompt at an artificial intelligence (AI) platform, which instructs the AI platform to generate a structured assessment of an application under test. The structured assessment includes a hierarchical structure of nodes and the prompt also includes instructions on how to maintain the hierarchical structure. When the AI platform returns the base structure, the hierarchical structure is visualized through an interactive graph (tree). The AI platform can change the structure of the tree by adding or deleting nodes or interact with an application-under-test through one of plural interfaces. Based on the results of the interaction, the AI platform is prompted on whether changes to the hierarchical structure are necessary or whether further interaction with the application-under-test is recommended. At each step, a human user may add or delete nodes from the tree to steer the cybersecurity engagement to different endpoints and objectives.

### RELATED APPLICATION

The application claims priority to U.S. Application No. 63/780,898 filed on Mar. 31, 2025, the entire content of which is hereby incorporated by reference in its entirety.

### FIELD

The present disclosure relates to the area of cybersecurity, and more particularly to systems and methods for performing offensive cybersecurity actions on a program.

### BACKGROUND

Cybersecurity technology encompasses a broad range of tools, systems, and methodologies designed to protect digital assets, networks, and data from malicious threats and unauthorized access. As cyber threats evolve rapidly, technological innovation remains critical for maintaining security. An effective cybersecurity program involves a balanced approach: defensive practices to safeguard assets and offensive practices to identify and mitigate vulnerabilities proactively. Both require continuous learning, adaptation, and adherence to ethical standards.

Defensive cybersecurity operations aim to protect systems, networks, and data from unauthorized access, attacks, and damage. Key defensive measures include conducting regular risk assessments and vulnerability management, deploying network security tools such as firewalls and intrusion detection or prevention systems, and segmenting networks to limit lateral movement. Organizations also implement endpoint security solutions like antivirus software and endpoint detection and response tools, along with enforcing strong access controls and multi-factor authentication. Data security measures such as encryption, regular backups, and data loss prevention strategies are also important. Security awareness training for staff helps prevent social engineering attacks, and continuous monitoring of network activity is essential for early threat detection. Establishing incident response plans and ensuring compliance with relevant regulations support the overall security posture.

Offensive cybersecurity operations involve activities designed to identify vulnerabilities, simulate adversary tactics, and test defenses. These activities include conducting authorized penetration tests and red team exercises, which often utilize tools like exploitation frameworks and custom scripts. Threat hunting and adversary simulation help organizations understand potential attack methods and improve their detection capabilities. Offensive operations also involve developing and validating exploits in controlled environments, as well as studying and mimicking attacker techniques. Training security teams in offensive techniques and participating in capture-the-flag competitions can enhance skills. Collaboration with industry groups and threat intelligence sharing contribute to understanding emerging threats and improving offensive strategies. It is important to conduct all offensive activities with proper authorization and within legal and ethical boundaries to prevent unintended harm.

Effective cybersecurity involves a balanced approach: defensive practices to safeguard assets and offensive practices to identify and mitigate vulnerabilities proactively. Both require continuous learning, adaptation, and adherence to ethical standards.

### SUMMARY

An exemplary method for generating an interactive cybersecurity platform is disclosed. The method comprising: executing, by a processor, program code for generating an interactive cybersecurity platform, upon execution of the program code the processor being configured with a trained neural network architecture to perform operations including: receiving, by an input device, a prompt with instructions for generating a dynamic, interactive graph structure of a software application under test; generating, by the processor, a dynamic, interactive graph structure of the software application under test in response to the prompt, the graph structure establishing a reasoning module having a hierarchical arrangement of plural nodes; generating, by the processor, plural interfaces for bi-directional communication with the software application under test, each interface being associated with one of the plural nodes such that interaction with one or more of the plural nodes activates the associated interface; and generating, by the processor, multiple parallel agents configured to traverse a subset of the plural nodes in the graph structure, the subset of nodes traversed by each agent are dynamically prioritized based on calculated scores representing exploit likelihood, vulnerability criticality, or previous interaction outcomes.

A system for generating an interactive cybersecurity platform is disclosed. The system comprising: memory configured to store program code for generating an interactive cybersecurity platform; and a processing device configured to execute the program code stored in memory, wherein upon execution the processing device being configured to: receive a prompt with instructions for generating a dynamic, interactive graph structure of the software application under test in response to the prompt, the graph structure establishing a reasoning module having a hierarchical arrangement of plural nodes; generate plural interfaces for bi-directional communication with the software application under test, each interface being associated with one of the plural nodes such that interaction with one or more of the plural nodes activates the associated interface; and generate multiple parallel agents configured to traverse a subset of the plural nodes in the graph structure, the subset of nodes traversed by each agent are dynamically prioritized based on calculated scores representing exploit likelihood, vulnerability criticality, or previous interaction outcomes.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates an offensive cybersecurity platform according to an embodiment of the present disclosure.

FIGS. 2A and 2B illustrate a hierarchical data structure generated according to an embodiment of the present disclosure.

FIG. 3 illustrates the reasoning module and application interfaces according to an embodiment of the present disclosure.

FIG. 4 illustrates a system components associated with AI agent deployment according to an embodiment of the present disclosure.

FIGS. 5A and 5B illustrate a structured graph with a queue of nodes according to an embodiment of the present disclosure.

FIG. 6 illustrates multiple AI agents according to an embodiment of the present disclosure.

FIG. 7 illustrates a method for performing offensive cybersecurity operations according to an embodiment of the present disclosure.

FIG. 8 illustrates a sample hardware architecture of the computing system according to an embodiment of the disclosure.

Further areas of applicability of the present disclosure will become apparent from the detailed description provided hereinafter. The detailed descriptions of exemplary embodiments are intended for illustration purposes only and are, therefore, not intended to necessarily limit the scope of the disclosure.

### DETAILED DESCRIPTION

The exemplary systems and methods of the present disclosure provide an artificial intelligence (AI)-native platform for offensive cybersecurity operations.

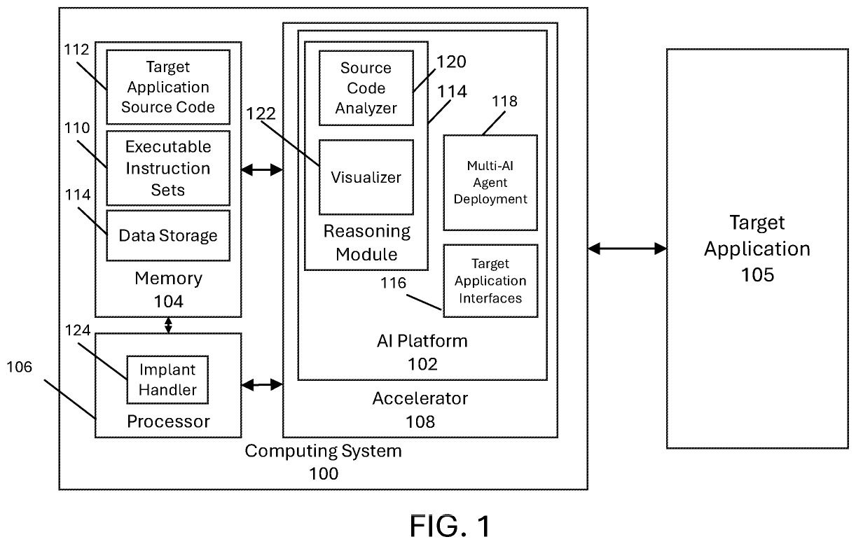

FIG. 1 illustrates an offensive cybersecurity platform according to an embodiment of the present disclosure. The system 100 can be a computing system configured with an AI platform 102 for performing cybersecurity penetration tests or vulnerability assessments of a target application 104. The target application 104 can be hosted on remote servers, cloud environments, or external networks. The AI platform 102 can be configured for a specific deployment can include setting network parameters, permissions, and possibly deploying agents or payloads depending on the testing scope. The AI platform 102 can serve as a co-pilot to human users for offensive cybersecurity actions, which structures an engagement and can use a set of interfaces to interact with different expressions of a program-under-test, be that source code, a running web application, or a compiled program. According to one example, the AI platform 102 can be deployed on a stand-alone system 100 from the target application 102. In another example, the AI platform 102 can be installed directly on the target system or within a controlled environment.

As shown in FIG. 1, the computing system 100 can include memory 104, a processor 106, and a hardware accelerator 108. The memory 104 can be configured for storing executable instruction sets 110 for each of the processor 106 (e.g., program instructions) and the hardware accelerator 108 (e.g., kernel instructions). The memory 104 can also store the source code 112 for the target application 102, which allows that application to be run and assessed locally on the computing system 100. A data store 114 can be a memory region that is allocated for storing information/data generated from the assessment of the target application 102. The processor 106 can be configured for running the source code for the target application 102. In addition, the processor 106 can be configured for communicating with the hardware accelerator 108 for assessing the target application 102. For example, control registers of the accelerator 108 can be mapped into system memory such that the processor 106 can configure and control the accelerator 108 via standard memory read and write operations. The processor 106 can send commands or configuration data to the hardware accelerator 108 through specified control registers or via command queues where tasks are posted for the accelerator 108 to process. Data transfer between the processor 106 and the accelerator is facilitated through mechanisms such as Direct Memory Access (DMA), which allows the accelerator to transfer data directly to and from memory without involving the processor 106, thereby enabling high-speed data movement. Alternatively, shared buffers can be used, where the processor 106 prepares data in designated memory regions that the accelerator 108 can then access.

The hardware accelerator 108 can be configured for performing the specialized operations and computational tasks for training, validating, and deploying the AI platform 102. The AI platform 102 can include one or more trained neural network architectures configured as one or more large language models (LLMs), which can include one or more of a recursive neural network (RNN), long short-term memory networks, transformer architectures, a generative adversarial network (GAN). According to an embodiment, the AI platform 102 can include a reasoning module 114, application interface modules 116, and multi-agent deployment modules 118.

The LLMs can include a neural network architecture with plural nodes that represent individual computational units. Each node has one or more biased input/output connections that function as transfer or activation functions for combining the inputs and outputs in a specified manner. Each node can have one or more inputs (i) and outputs (o) for processing the data. The plural nodes can be arranged into multiple layers, where the scheme within which the nodes are connected determines the type and operation of the neural network. The multiple layers can include an input layer, multiple hidden layers, and an output layer. Each layer may perform a different or specified transformation on the respective inputs, using a different or specified mathematical calculation or function. Signals travel or are passed between the layers, from the input layer to the output layer via the middle or hidden layers 508_{HID} and can traverse any layer and node(s) multiple times. Further, the nodes can be connected in an array and each node can transmit a signal to a node in another layer of the neural network. The input/output connections between the nodes have a corresponding weight wₙⱼ and are combined according to the bias applied at each node. For example, the connections can be activation or transfer functions which trigger the respective nodes and combine inputs according to mathematical equations or formulas according to the bias. Data can be received at an input layer and passed through multiple hidden layers for performing an operation according to the task prompt.

The reasoning module 114 is configured to operate under a “tree of thought” framework. As a result, the reasoning module 102 can be configured to organize, visualize, and analyze complex problem-solving processes or reasoning pathways for performing an offensive cybersecurity test. The reasoning module 114 can include a source code analyzer 120 and a visualizer 122. The source code analyzer 120 analyzes the source code of the target application 102 to generate a structured assessment of an application, along with some instructions about how to maintain the structure. The source code analyzer 122 can be configured to perform on-demand review of source files across diverse languages by receiving environment data, such as file contents and search results, via the application interfaces 116. A continuous read-write pattern can be performed by a specialized instruction and response loop executed by the processor 106. This process yields a flexible code review process that is shaped concurrently by the AI platform 108 and a user. The system can dynamically decide to continue analyzing code, refine previous insights, or pivot to other interfaces to correlate data between the interfaces.

The visualizer 124 receives the results of the source code analysis from the source code analyzer 122 and can generate a structured assessment of the application. The structured assessment can include a hierarchical arrangement of nodes, where each branch in the hierarchy signifies a different line of reasoning, option, or outcome for performing the test. The plural nodes represent discrete units of thought and interaction with one of the plural nodes causes the processor to perform a reasoning process, a task or subtask on the software application under test, an organizational shell, or an asset visualization. The edges of the graph structure represent logical or causal relationships among the plural nodes, such that the graph structure dynamically evolves based on real-time interface interactions, adaptive task outcomes, user interactions guiding agent behavior, user-suggested tasks prompting node creation, and ongoing analysis derived from bidirectional communication with interfaces and agents. The “central idea” or testing scheme can be established through a prompt is sent to the AI platform 102 to ask it to generate a structured assessment of an application, along with some instructions about how to maintain the testing structure.

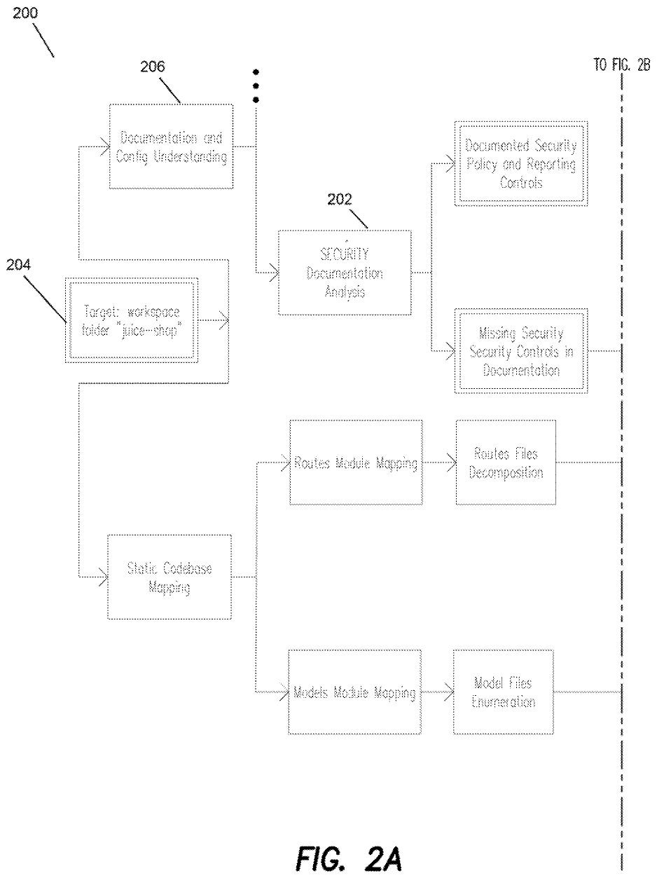

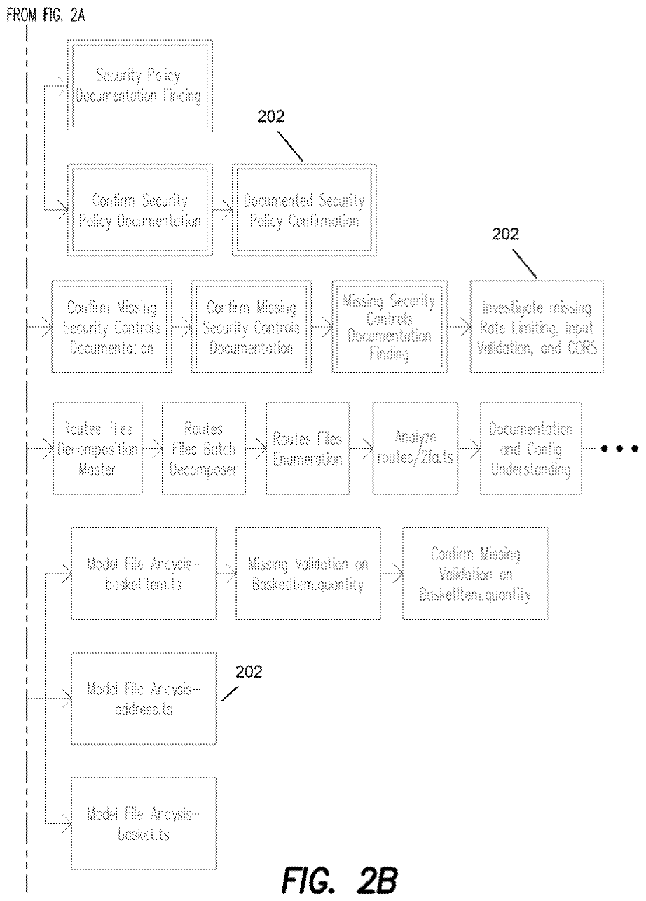

FIGS. 2A and 2B illustrate a hierarchical data structure generated according to an embodiment of the present disclosure. The structured assessment 200 of the target application 102 can be visualized as an interactive graph (tree). In the example of FIGS. 2A and 2B, the target application is used for managing a database. The base structure can include plural nodes 202 for various testing options for assessing the target application. The structured Each node represents a distinct line of inquiry or task. This node-level organization is maintained in a persistent graph, and the nodes can be added, deleted, rearranged as new information is learned to expand or update branches. As shown in FIGS. 2A and 2B, the lead nodes 204, 206 indicate the application to be tested (204) and the purpose of the route to be traversed (206) overall operation to be performed. These operations can include the nodes can include but are not limited to vulnerability scanning, which involves automated identification of known weaknesses in systems, services, or applications. For example, the nodes can include an analysis of a services loader, constants, registration entry points, public entry points, and any other suitable aspects of the application as defined by the source code. The nodes can look for common security issues such as injection flaws, buffer overflows, insecure configurations, and improper error handling. The node operation can analyze how data moves through the code and how control structures are used, helping identify vulnerabilities like SQL injection, cross-site scripting (XSS), or insecure data handling. The LLM returns the base structure as a visualization of an interactive graph (tree). Then, based on the structure of this tree, the LLM is prompted for a next step. Each node in the interactive graph can lead to multiple subsequent nodes, illustrating different possibilities or reasoning paths. Each node can receive a prompt at one of the plural nodes 204, the prompt including instructions for modifying the hierarchical arrangement of the plural nodes or instructions for interacting with the target application 105 through one of the plural interfaces. When a node 204 is selected and interacts with the software application and receives information from the target application 105 via the selected node 204, any information received from the target application is used to update the node 204.

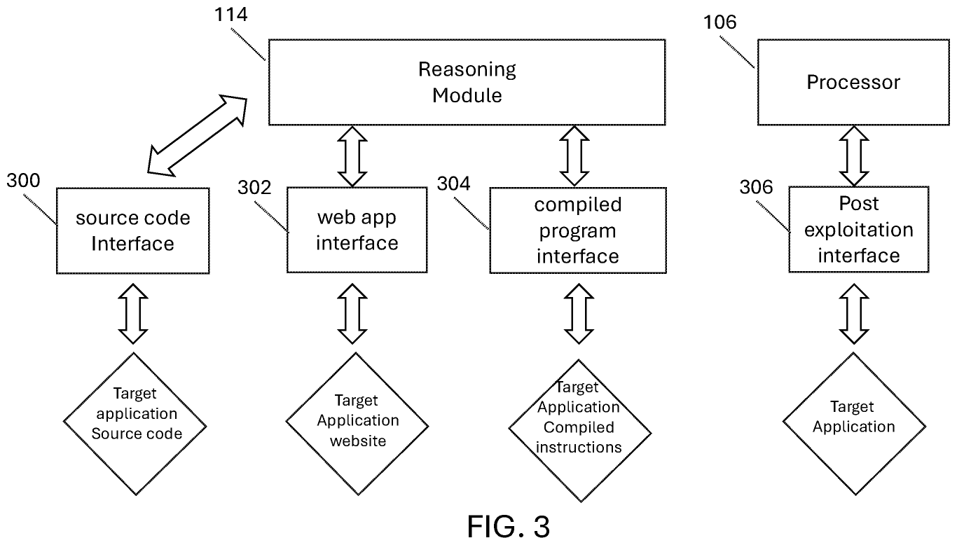

FIG. 3 illustrates the reasoning module and application interfaces according to an embodiment of the present disclosure. The reasoning module 114 interacts with the target application 102 via the target application interfaces 116. The reasoning module 114 sends instructions to the target application 102 via the target application interfaces 116. The target application interfaces 114 receives information from the target application in response to the instructions and standardizes the response for digestion by the reasoning module 114. The interfaces can include a source code interface 300, a web app interface 302, and a compiled program interface 304, or other file-based or dynamic execution interfaces, each interface can be configured for structured, interactive, and adaptive analysis, wherein these interfaces incorporate universal parsing capabilities, language-agnostic methodologies, and dynamically loadable extension mechanisms, enabling automated adaptability to unknown or newly encountered software and environments.

The source code interface 300 can be implemented as an AI agent that facilitates structured, on-demand review of source files across diverse languages. In one embodiment, the source code interface 300 can access the source code of the target application and create a duplicate for storage in memory 112. The source code interface 300 can interact with the reasoning module 114 such that the reasoning module 114 can perform automated control functions such as starting and stopping the source code interface as needed.

The web application interface 302 can be configured for direct control and real-time interactive execution of browser-based user-like actions within the web application under test, wherein detailed, selectively truncated request-response data pairs resulting from interactions are captured, analyzed, and immediately integrated into the hierarchical reasoning module to refine cybersecurity analysis dynamically. The web app interface 302 can be another AI agent that allows for direct control of the browser at a low level, dynamically processing live document object model (DOM) and hypertext markup language (HTML) content, and replicating any user interaction within a web application exactly as a human user or developer would. The interaction is enabled with specialized commands to browse to pages, click elements, fill forms, execute JavaScript and retrieving structured HTML in a parsed JSON Table of Contents format. The environment decides what to send back to the processor to guide iterative analysis. The web application interface can be configured to dispatch web page sub-commands for executing user-like actions on the web page of the software application under test. Further, the web application interface 302 can interpret web application commands and responses dynamically, recognizing and adaptively navigating or intelligently circumventing encountered application-specific security constraints by adjusting interface actions based on real-time detection of defensive measures, application responses, or error conditions

The system listens for sub-commands from the AI logic (e.g., “navigate,” “click,” “fill”) and dispatches the commands to a browser manager. The browser manager executes user-like actions in a headless session (i.e., no direct physical interaction), collecting requests and response data remotely over a network such as via SSH, RDP, or VNC. A subcommand processor interprets directives such as “browser fill” or “browser exec,” ensures that the commands align with security constraints, and feeds the outcome—HTML diffs, status updates, or partial DOM snapshots—back into the structured graph of the reasoning module 114. The round-trip mechanism can transform real-time browser interactions into actionable intelligence within the logic graph. Each click or fill is added as a node history item, enabling the reasoning module 114 to reflect on each observed state change and plan deeper or alternative next steps.

The compiled program interface 304 can be configured to operate as the ability to run a decompilation, a disassembler, and a debugger. For example, the compiled program interface 304 can include a debugger, such as a GNU debugger, which uses a command-line for debugging program code or compiled program instructions. The command-line can be used for duplicating the machine code to develop a new independent version The duplicated machine code is then provided to the reasoning module 114 for disassembly, decompiling, and debugging of the binary code, interactively with the human user.

The application interfaces 116 also includes a post-exploitation framework interface configured to dynamically generating, deploying, and managing custom payloads directly derived from initial successful exploits or user-provided proofs-of-concept (PoCs). In one embodiment, the post-exploitation interface 306 can include an automated payload generation engine that translates exploit outcomes—such as remote code execution or shell access—into persistent, interactive implants capable of maintaining communication channels back to the computing system 100 or processor 106. The implants can include software code or a software tool that is embedded into the target application 102 to perform malicious and/or unauthorized actions. The post-exploitation interface 306 facilitates user control over the implants through instructions for executing specific tasks. Additionally, the computing system 100 can be configured to include a robust implant handler 124 to manage these dynamically generated implants, enabling ongoing command execution, system reconnaissance, lateral movement, and persistence management. The computing system 100 or processor 106 can integrate implant actions and their outcomes into the reasoning module 122 by automatically updating the structured or exploitation graph to reflect newly discovered information or propagation paths.

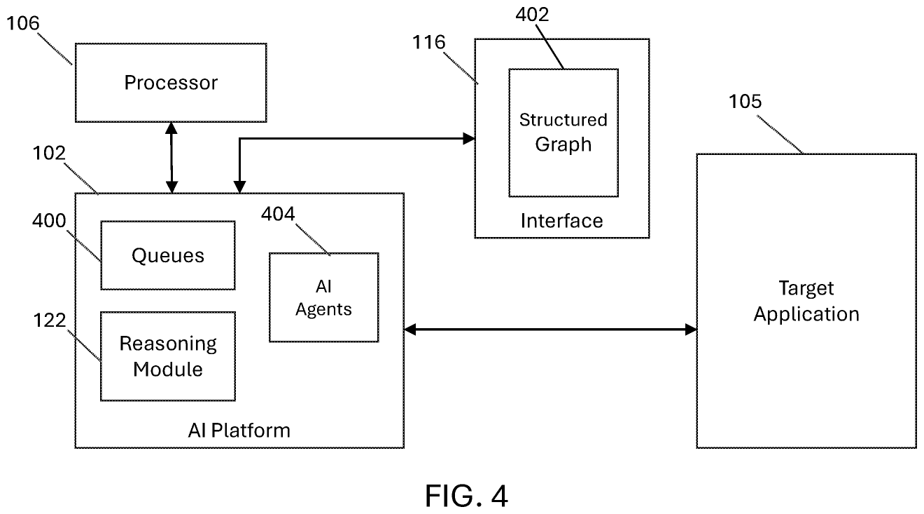

After the reasoning module 122 generates and/or builds the structured graph from information and data obtained from the target application 102, the computing system 102 can deploy multiple AI agents to traverse the structured graph and simultaneously perform multiple exploitation operations asynchronously. FIG. 4 illustrates a system components associated with AI agent deployment according to an embodiment of the present disclosure. According to one embodiment, the AI platform 102 can include multiple queues 400 which prioritize the nodes in the structured graph 402. A user can submit a query to the AI platform 102 for scoring the nodes based on their likelihood of resulting in a compromise of the application. In response to the query, the AI platform 102 can move nodes with higher scores to higher positions in the queue or to the top of the queue so that operations associated with the nodes can be the first performed by the multiple AI agents 404. The processor 106 can be configured to deploy the AI agents 404 for performing the operations of each node according to the node sequence provided in the queue 400. In one embodiment, the processor 102 can be configured to control the timing of the multiple AI agents 404 such that the operation of a current node in the queue 400 can be initiated only upon receipt of an indication (signal) that the operation of a preceding node 400 in the queue has been completed.

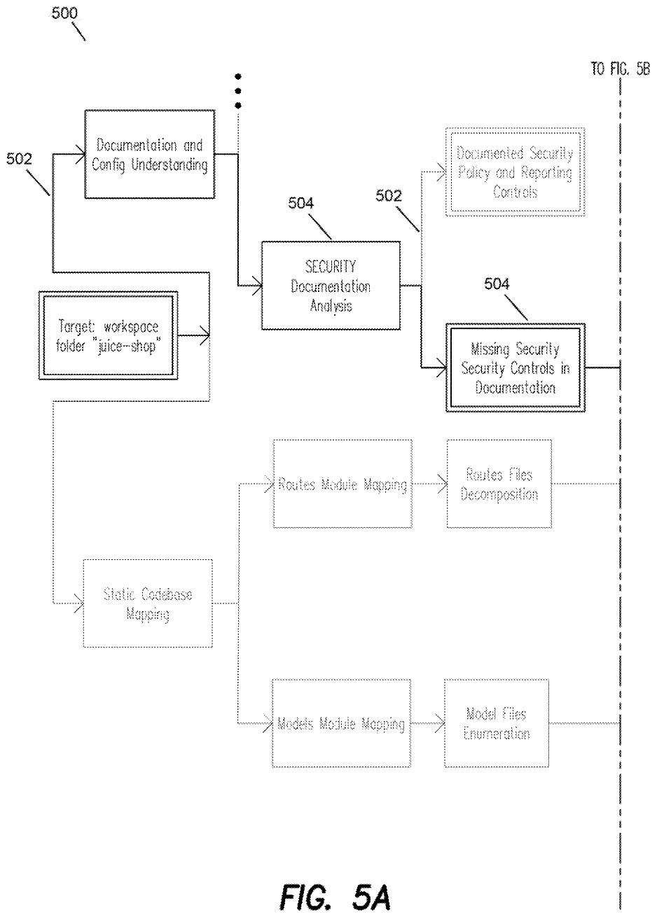

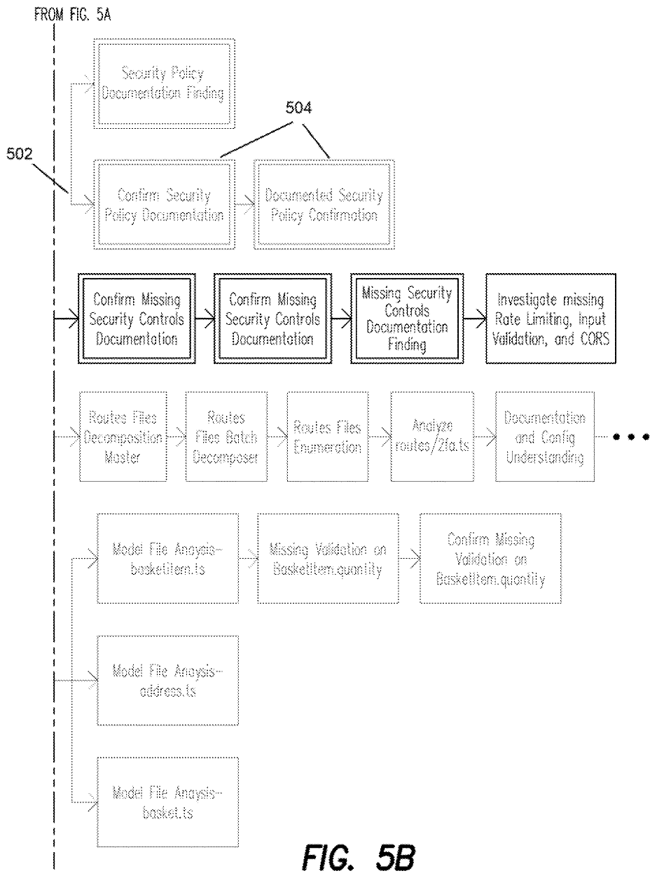

FIGS. 5A AND 5B illustrate a structured graph with a path of prioritized nodes according to an embodiment of the present disclosure. As shown in FIGS. 5A and 5B, the structured graph 500 includes a path 502 of highlighted nodes 504 that are prioritized through one of the queues 400 such that they are performed in a specified sequence.

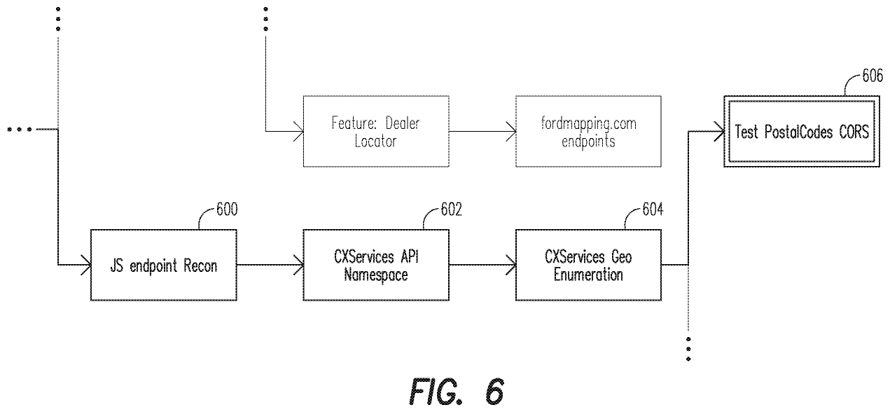

FIG. 6 illustrates multiple AI agents according to an embodiment of the present disclosure. As shown in FIG. 6, an AI agent can be deployed to perform the operation of each node in a sequence defined by a path. For example, AI agents 600, 602, 604, 606 are deployed to perform a sequence of operations for a targeted application according to the sequence provided in the queue.

The processor can control the AI platform 102 and the reasoning module 122, particularly, for creating multiple classes of nodes to properly orchestrate the sequence of operations performed by the multiple AI agents 404. For example, an “orchestrator” class of node can be created to oversee the whole run. An “action” node class can be created to represent actions against a section of the program-under-test. An “attack” node class can be created to house the attempted exploits against a particular part of a program-under-test. A “finding” node class can be created to represent the findings to the user.

The computing system 100 implements a layer of parallelism in which each agent can pursue separate tasks (e.g., enumerating endpoints, scanning code fragments, or attempting exploits) without blocking or preventing another operation from proceeding before the specified task(s) is(are) completed. As already discussed, the parallelism can be realized through the scoring of nodes, which ensures that the most promising vulnerabilities receive the highest or immediate attention. The merging of the node ranking, organization and scheduling logic with the structured graph enables the computing system to seamlessly provide updates on the sequence of operations to be performed and the reassignment of tasks. The computing system allows multiple angles of attack to be performed simultaneously in real time while maintaining one global, self-consistent representation of the engagement in a graph of thoughts.

In response to the prompt, the LLM may choose to (i) change the structure of the tree (e.g., add or delete a node) or (ii) interact with a program-under-test (e.g., software application under test) through one of its interfaces 104, 106, 108.

Based on the results of the interaction with the program-under-test, the LLM is prompted to determine whether it would like to change the structure of the tree or interact with the program-under-test through its interfaces. At each step, in addition to the LLM, a human user may add or delete nodes from the tree to steer the cybersecurity engagement to different endpoints and objectives.

The nodes are arranged hierarchically, and each node represents a distinct line of inquiry or task. This node-level organization is maintained in a persistent graph, enabling the system to expand or update branches as it learns new information. The method's uniqueness stems from continually re-prompting a model with a tree-structured state, which yields a more adaptive, self-correcting, and traceable vulnerability exploration than a standard linear workflow. The module's flexibility also allows human operators to inject domain expertise directly into the branching logic dynamically at runtime.

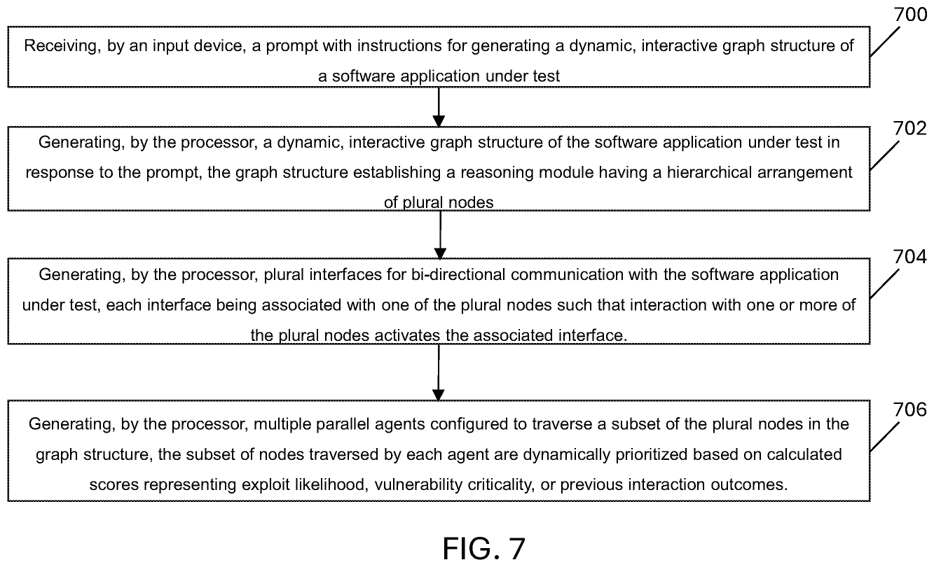

FIG. 7 illustrates a method for performing offensive cybersecurity operations according to an embodiment of the present disclosure. In performing the method, the processor 106 can execute program code 110 for generating an interactive cybersecurity platform, upon execution of the program code the processor being configured with a trained neural network architecture (AI platform 102) for performing various operations. Step 700 of the method includes receiving, by the processor 106 through an input device, a prompt with instructions for generating a structured graph 402 (e.g., dynamic, interactive graph structure) of a target application 105 (e.g., software application under test). The processor 106 via the reasoning module 122 of the AI platform 102 can generate the structured graph 402 in response to the prompt (Step 702). The structured graph 402 having a hierarchical arrangement of plural nodes representing vulnerability testing operations that can be performed in the target application. In Step 704, the processor generates plural interfaces 116 for bi-directional communication with the software application under test, each interface being associated with one of the plural nodes such that interaction with one or more of the plural nodes activates the associated interface 300, 302 306. The processor 106 can further generate multiple parallel AI agents 404 configured to traverse a subset of the plural nodes in the graph structure 402 (Step 706). The subset of nodes traversed by each agent are dynamically prioritized based on calculated scores representing exploit likelihood, vulnerability criticality, or previous interaction outcomes.

According to a further embodiment, the processor 106 can receive a prompt including an instruction for performing an action associated with the hierarchical arrangement of plural nodes in the structured graph 402. The hierarchical arrangement of the plural nodes can be adjusted by adding or removing at least one of the plural nodes. For example, the structured graph 402 can be updated as more information about the target application 105 is learned. In addition, the prompt can include a request to prioritize those nodes which can perform operations which pose the greatest risk to the target application 105. The processor can select one of the plural nodes to extract information from the software application under test and receive information from the software application under test via the selected node. The hierarchical arrangement of the plural nodes can be updated by the reasoning module 122 based on the information received from the selected node. The update can be initiated by a user prompt, which can include instructions for interacting with software application under test through one of the plural interfaces.

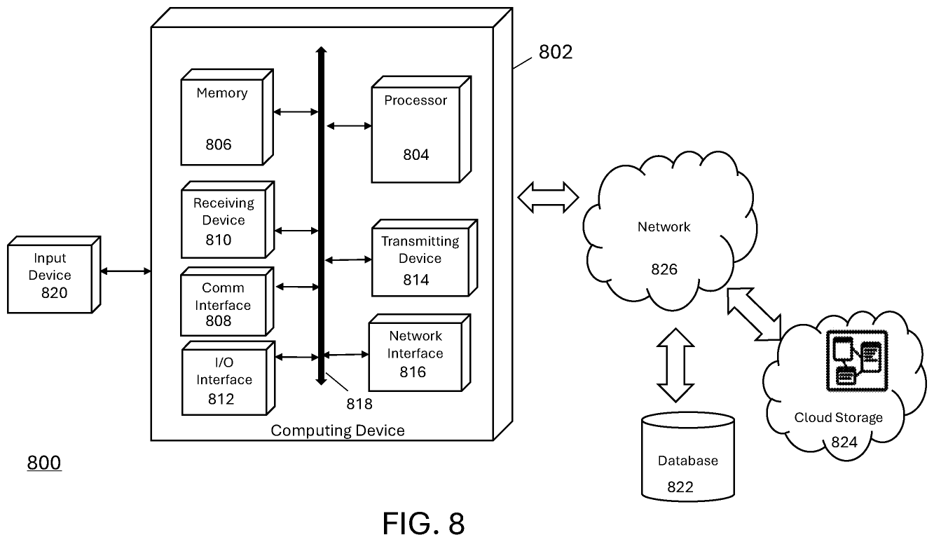

FIG. 8 illustrates a sample hardware architecture of the computing system according to an embodiment of the disclosure. An exemplary system 800 including a computing device 802. The computing device 802 may include a processor 804 and memory 806.

The processor 804 may be implemented in hardware, software, or a combination of hardware and software. For example, the processor 804 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function.

Memory 806 may include random access memory (RAM), read-only memory (ROM), and/or another type of dynamic or static storage device (e.g., flash memory, magnetic memory, optical memory, etc.) that stores information and/or software instructions for use by the processor. Memory 806 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 806 from another computer-readable medium or from another device via a communication interface with a computing device. When executed, software instructions stored in memory may cause the processor 804 to perform one or more processes described herein. Embodiments described herein are not limited to any specific combination of hardware circuitry and software.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”) or distributed among two or more substrates. Various functional aspects of the processor may be implemented solely as software or firmware associated with the processor.

The processor 804 can include one or more processing or operating modules. A processing or operating module can be a software or firmware operating module configured to implement any of the functions disclosed herein. The processing or operating module can be embodied as software and stored in memory. The memory can be operatively associated with the processor. A processing module can be embodied as a web application, a desktop application, a console application, etc.

The processor 804 can include or be associated with a computer or machine-readable medium. The computer or machine-readable medium can include memory. Any of the memory discussed herein can be computer readable memory configured to store data. The memory 806 can include a volatile or non-volatile, transitory or non-transitory memory, and be embodied as a database 822, an active memory, a cloud memory, cloud storage, or cloud servers 824, or any other suitable device or system as desired. Examples of memory 806 can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor 804.

Embodiments of the memory 806 can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, waveguides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device 802 (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory 806.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device 802 can also include a communications interface 808. The communications interface 808 can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface 808 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other forms of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor devices to implement the methods as discussed herein. Accordingly, such computer programs can represent controllers of the computing device.

According to exemplary embodiments described herein, the memory 806 and the processor 804 can store and/or execute computer program code for performing the specialized functions described herein. The program code can be stored on a non-transitory computer readable medium, such as the memory devices for the system (e.g., computing device), which may be memory semiconductors (e.g., DRAMs, etc.) or other tangible non-transitory means for providing software to the system. The computer programs (e.g., computer control logic) or software may be stored in memory devices (e.g., device memory) resident on/in the system. The computer programs may also be received from external storage devices and/or network storage locations via a communications interface. Such computer programs, when executed, may enable the system to implement the present methods and exemplary embodiments discussed herein. Accordingly, such computer programs may represent controllers of the system. Where the present disclosure is implemented using software, the software may be stored in a computer program product or non-transitory computer readable medium and loaded into the system using any one or combination of a removable storage drive, an interface for internal or external communication, and a hard disk drive, where applicable.

The one or more processors of the computing system can include one or more modules or engines configured to perform the functions of the exemplary embodiments described herein. Each of the modules or engines can be implemented using hardware and, in some instances, can also utilize software, such as program code and/or programs stored in memory. In such instances, program code may be compiled by the respective processors (e.g., by a compiling module or engine) prior to execution. For example, the program code can be source code written in a programming language that is translated into a lower-level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that may be suitable for translation of program code into a lower-level language suitable for controlling the computing system to perform the functions disclosed herein. It will be apparent to persons having skill in the relevant art that such processes result in the computing system being specially configured computing systems uniquely programmed to perform the functions discussed above.

The computing system 800 may further include a receiver or receiving device 810, a network interface, an input/output (I/O) interface 812, a transmitting device 814, a communication infrastructure 818, and an input device 820.

The receiver or receiving device 810 may be a combination of hardware and software components. According to exemplary embodiments, the receiving device 810 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The hardware and software components of the receiving device can be configured to receive the data from a network according to one or more communication protocols and data formats. For example, the receiving device 810 can be configured to communicate over a network, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device can be configured to identify parts of the received data via a header and parse the data signal and/or data packet into small frames (e.g., bytes, words) or segments for further processing at the processor.

The I/O interface 812 can be configured to receive the signal from the processor and generate an output suitable for a peripheral device via a direct wired or wireless link. The I/O interface 812 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 814 can be configured to receive data from the processor and assemble the data into a data signal and/or data packets according to the specified communication protocol and data format of a peripheral device or remote device to which the data is to be sent. The transmitting device 814 can include any one or more of hardware and software components for generating and communicating the data signal over the communications infrastructure and/or via a direct wired or wireless link to a peripheral or remote device. The transmitting device 814 can be configured to transmit information according to one or more communication protocols and data formats as discussed in connection with the receiving device 810.

The computing system can be connected to peripheral devices such as a display device configured to display one or more interfaces and/or images generated by the CPU and GPU. The GPU can be configured to generate a data signal encoded with the video data and send the data signal to the display device via the communications infrastructure. The display device can include any one of several types of displays including light emitting diode (LED), micro-LED, organic LED (OLED), active-matrix organic LED (AMOLED), Super AMOLED, thin film transistor (TFT), TFT liquid crystal display (TFT LCD), in-plane switching (IPS), or any other suitable display type as desired. According to an exemplary embodiment, the display device can be configured to have a resolution at any of 5K, 4K, 2K, high definition (HD), full HD, and a refresh rate including any one of 60 Hz, 90 Hz, 120 Hz or any other suitable resolution and refresh rate as desired.

Thus, it will be appreciated by those skilled in the art that the disclosed systems and methods can be embodied in other specific forms without departing from the spirit or essential characteristics thereof. The presently disclosed implementations are therefore considered in all respects to be illustrative and not restricted. It is not exhaustive and does not limit the disclosure to the precise form disclosed. Modifications and variations are possible considering the implementations disclosed herein, or may be acquired from practicing of the disclosure, without departing from the breadth or scope. Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an implementation, B alone may be present in an implementation, C alone may be present in an implementation, or that any combination of the elements A, B and C may be present in a single implementation; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such as a process, method, article, or apparatus that comprises a list of elements does not include only those elements but may include other elements not expressly listed or inherent to such process, method, article, or apparatus.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A method for generating an interactive cybersecurity platform, the method comprising:
executing, by a processor, program code for generating an interactive cybersecurity platform, upon execution of the program code the processor being configured with a trained neural network architecture to perform operations including:
receiving, by an input device, a prompt with instructions for generating a dynamic, interactive graph structure of a software application under test;
generating, by the processor, a dynamic, interactive graph structure of the software application under test in response to the prompt, the graph structure establishing a reasoning module having a hierarchical arrangement of plural nodes;
generating, by the processor, plural interfaces for bi-directional communication with the software application under test, each interface being associated with one of the plural nodes such that interaction with one or more of the plural nodes activates the associated interface; and
generating, by the processor, multiple parallel agents configured to traverse a subset of the plural nodes in the graph structure, the subset of nodes traversed by each agent are dynamically prioritized based on calculated scores representing exploit likelihood, vulnerability criticality, or previous interaction outcomes.

2. The method of claim 1, further comprising:
receiving, by the processor, a prompt including an instruction for performing an action associated with the hierarchical arrangement of plural nodes; and
modifying, by the processor, the hierarchical arrangement of plural nodes by adding or removing at least one of the plural nodes.

3. The method of claim 1, further comprising:
receiving, by the processor, a prompt including an instruction for performing an action associated with the hierarchical arrangement of plural nodes; and
selecting, by the processor, one of the plural nodes to extract information from the software application under test.

4. The method of claim 3, further comprising:
receiving, by the processor, information from the software application under test via the selected node; and
updating, by the processor, at least one of the plural nodes and/or a branch of the hierarchical arrangement of plural nodes based on the received information.

5. The method of claim 3, further comprising:
receiving, by the processor, a prompt at one of the plural nodes, the prompt including instructions for modifying the hierarchical arrangement of the plural nodes or instructions for interacting with software application under test through one of the plural interfaces.

6. The method of claim 1, further comprising:
receiving, by the processor via one of the plural interfaces, the information from the software application under test; and
determining, by the processor, one or more data items in the received information to send to the reasoning module for processing, the plural nodes interacting with the software application under test based on the information contained in the one or more data items.

7. The method of claim 6, wherein receiving the information from the software application under test comprises:
receiving, by the processor, at least one of source code, contents of a file, and hypertext markup language (HTML) of a web page.

8. The method of claim 1, wherein generating the plural interfaces comprises:
generating, by the processor, a source code interface, a compiled program interface, a live web application interface, and other file-based or dynamic execution interfaces, each interface being configured for structured, interactive, and adaptive analysis, wherein these interfaces incorporate universal parsing capabilities, language-agnostic methodologies, and dynamically loadable extension mechanisms, enabling automated adaptability to unknown or newly encountered software and environments.

9. The method of claim 1, wherein generating the plural interfaces comprises:
generating, by the processor, a web application interface configured for direct control and real-time interactive execution of browser-based user-like actions within the web application under test, wherein detailed, selectively truncated request-response data pairs resulting from interactions are captured, analyzed, and immediately integrated into the hierarchical reasoning module to refine cybersecurity analysis dynamically.

10. The method of claim 9, further comprising:
dispatching, by the processor via the web application interface, web page sub-commands for executing user-like actions on the web page of the software application under test; and
interpreting, by the processor via the web application interface, web application commands and responses dynamically, recognizing and adaptively navigating or intelligently circumventing encountered application-specific security constraints by adjusting interface actions based on real-time detection of defensive measures, application responses, or error conditions.

11. The method of claim 1, wherein generating the plural interfaces comprises:
generating, by the processor, a compiled program interface configured to decompile, disassemble, and debug binary code received included in the source code of the software application under test.

12. The method of claim 1, wherein generating the plural interfaces comprises:
generating, by the processor, a post-exploitation framework interface configured for controlling the software application under test based on remote-access tool (RAT) executable code and RAT documentation received by the processor from a user.

13. The method of claim 1, comprising:
continuously updating the graph structure based on interactions with the software application under test based on plural user inputs or prompts.

14. The method of claim 1, wherein the plural nodes represent discrete units of thought and interaction with one of the plural nodes causes the processor to perform a reasoning process, a task or subtask on the software application under test, an organizational shell, or an asset visualization.

15. The method of claim 1, wherein edges of the graph structure represent logical or causal relationships among the plural nodes, such that the graph structure dynamically evolves based on real-time interface interactions, adaptive task outcomes, user interactions guiding agent behavior, user-suggested tasks prompting node creation, and ongoing analysis derived from bidirectional communication with interfaces and agents.

16. The method of claim 1, wherein generating the multiple parallel agents comprises:
guiding parallel actions performed by the multiple agents based on the prioritized nodes through coordinated, conflict-free task assignment and efficient management via a priority queue shared by the multiple agents.

17. A system for generating an interactive cybersecurity platform, the system comprising:
memory configured to store program code for generating an interactive cybersecurity platform; and
a processing device configured to execute the program code stored in memory, wherein upon execution the processing device being configured to:
receive a prompt with instructions for generating a dynamic, interactive graph structure of the software application under test in response to the prompt, the graph structure establishing a reasoning module having a hierarchical arrangement of plural nodes;
generate plural interfaces for bi-directional communication with the software application under test, each interface being associated with one of the plural nodes such that interaction with one or more of the plural nodes activates the associated interface; and
generate multiple parallel agents configured to traverse a subset of the plural nodes in the graph structure, the subset of nodes traversed by each agent are dynamically prioritized based on calculated scores representing exploit likelihood, vulnerability criticality, or previous interaction outcomes.

18. The system of claim 17, wherein the processing device is configured to:
receive, via one of the plural nodes, a prompt including instructions for modifying the hierarchical arrangement of the plural nodes or instructions for interacting with software application under test through one of the plural interfaces.

19. The system of claim 17, wherein the processing device is configured to:
receive, via one of the plural interfaces, the information from the software application under test; and
determine one or more data items in the received information to send to the hierarchical arrangement of plural nodes for interacting with the software application under test.

20. The system of claim 17, wherein the processing device is configured to:
receive at least one of source code, contents of a file, and hypertext markup language (HTML) of a web page.

21. The system of claim 17, wherein the processing device is configured to:
generate a source code interface, a compiled program interface, a live web application interface, and other file-based or dynamic execution interfaces, each interface being configured for structured, interactive, and adaptive analysis, wherein these interfaces incorporate universal parsing capabilities, language-agnostic methodologies, and dynamically loadable extension mechanisms, enabling automated adaptability to unknown or newly encountered software and environments.

22. The system of claim 17, wherein the processing device is further configured to:
generate a web application interface configured for direct control and real-time interactive execution of browser-based user-like actions within the web application under test, wherein detailed, selectively truncated request-response data pairs resulting from interactions are captured, analyzed, and immediately integrated into the hierarchical reasoning module to refine cybersecurity analysis dynamically.

23. The system of claim 22, wherein the processing device is configured to:
dispatch, via the web application interface, web page sub-commands for executing user-like actions to the web page; and
interpret, via the web application interface, web page commands to ensure that the commands align with security constraints of the software application under test.

24. The system of claim 17, wherein the processing device is configured to:
generate a compiled program interface for decompiling, disassembling, and debugging source code received from the software application under test.

25. The system of claim 17, wherein the processing device is configured to:
generate a post-exploitation framework interface for controlling the software application under test based on remote-access tool (RAT) executable code and RAT documentation received by the processor from a user.

26. The system of claim 17, wherein the processor is configured to:
continuously update the graph structure based on interactions with the software application under test based on plural user inputs or prompts.

27. The system of claim 17, wherein the plural nodes represent discrete units of thought and interaction with one of the plural nodes, and wherein the processor is configured to:
perform a reasoning process, a task or subtask on the software application under test, an organizational shell, or an asset visualization.

28. The system of claim 17, wherein edges of the graph structure represent logical or causal relationships among the plural nodes, such that the graph structure dynamically evolves based on real-time interface interactions, adaptive task outcomes, user interactions guiding agent behavior, user-suggested tasks prompting node creation, and ongoing analysis derived from bidirectional communication with interfaces and agents.

29. The system of claim 17, wherein to generate the multiple parallel agents, the processor is configured to:
guide parallel actions performed by the multiple agents based on the prioritized nodes through coordinated, conflict-free task assignment and efficient management via a priority queue shared by the multiple agents.
